(19) United States
(12) Patent Application Publication
(10) Pub. No.: US 2025/0208248 A1
(43) Pub. Date: Jun. 26, 2025

(54) A SYSTEM AND METHOD OF DETECTING A DIRECTION OF ARRIVAL OF ONE OR MORE TARGET SIGNALS USING AN ANTENNA ARRAY

(71) Applicant: Agency for Science, Technology and Research, Singapore (SG)

(72) Inventors: Xinyi TANG, Singapore (SG); Xianming QING, Singapore (SG)

(21) Appl. No.: 18/851,822

(22) PCT Filed: Mar. 31, 2023
(86) PCT No.: PCT/SG2023/050221

§ 371 Date: Sep. 27, 2024

(30) Foreign Application Priority Data
Mar. 31, 2022 (SG) 10202203290W

(51) Int. Cl. G01S 3/04; H01Q 21/24

(52) U.S. Cl. CPC G01S 3/04; H01Q 21/24

(57) ABSTRACT

There is provided a system and method of detecting a direction of arrival of one or more target signals using an antenna array, the method comprising, i) generating a map representing a ratio of a co-polarization (Co-pol) pattern received by the first beam to a cross-polarization (X-pol) pattern received by the second beam; ii) obtaining Co-pol and X-pol signal strengths of the one or more target signals received by the first and second beams in step (i); iii) obtaining the Co-pol to X-pol ratio of each of the one or more target signals; iv) normalizing the generated map; v) normalizing the Co-pol to X-pol ratios of the one or more target signals; and vi) for each target signal: finding area(s), within the normalized generated map, which substantially match the normalized Co-pol to X-pol ratio of the target signal; and identifying said area(s) of the normalized generated map as potential direction(s) of arrival of the target signal.

### TECHNICAL FIELD

The present disclosure relates broadly to a system and method of detecting a direction of arrival of one or more target or source signals using an antenna array.

### BACKGROUND

Radio frequency (RF) sensing is a technique for sensing objects or movement in an environment based, at least in part, on the transmission and reception of electromagnetic signals. For example, a person moving through the environment interferes with the electromagnetic signals that are transmitted by a transmitting device. A receiving device may detect and characterize such changes to its received signals to determine the speed or direction of the person's movement.

Accurate RF sensing of the locations of desired targets or sources serves as one of the most important preconditions to subsequent decision-making algorithms for any smart platform that needs navigation. Possible applications include the next generation anti-spoofing Global Navigation Satellite Systems (GNSS), radars etc.

Conventionally, the target or source locations are realized by physically or digitally steering antenna beams (e.g., of antenna arrays) to different directions. If a relatively high resolution is required, the antenna arrays need to produce narrow beams in order to differentiate targets or sources that are spaced close to each other. With this conventional approach, antennas with relatively large radiation apertures are unavoidable to achieve high resolution. For active array or multiple-input-multiple-output (MIMO) implementations, a large number of RF and digital-to-analog converter (DAC)/analog-to-digital converter (ADC) channels are used. In such cases, the overall system cost and occupied areas are dramatically increased.

Conventionally, for a linear antenna array with equally spaced antenna elements, the following relation is used for calculating a 3 dB beamwidth:

$$3 dB Beamwidth \approx 0.886 \times \frac{λ}{Nd cos θ}$$

where λ is the free space wavelength at the operating frequency, N is the number of the antenna elements, d is the spacing between adjacent antenna elements and θ is the angle from the boresight of the array.

From the above relation, it is clear that when the resolution requirement is reduced by a factor of 2, the antenna aperture size is doubled, and the number of channels is also doubled. When a concept like virtual MIMO array is used, the total number of physical channels reduces, but the overall antenna size remains similar to keep the aperture size as required by the high resolution.

For example, to achieve a resolution of 5-degree in one dimension (azimuth), with a half-wavelength element spacing, at least 20 elements or a similar aperture along that direction are needed. When the same resolution is required in two dimensions (azimuth and elevation), at least 400 elements or a similar aperture are needed. Accordingly, it is difficult to achieve comparable resolution in two dimensions without increasing the number of elements.

Thus, there is a need for a system and method of detecting a direction of arrival of one or more target signals using an antenna array which seek to address or at least ameliorate one of the above problems.

### SUMMARY

In accordance with a first aspect of the present disclosure, there is provided a method of detecting a direction of arrival of one or more target signals using an antenna array configured to form a first and a second beam in various configurations, the method comprising, i) generating a map representing a ratio of a co-polarization (Co-pol) pattern received by the first beam to a cross-polarization (X-pol) pattern received by the second beam; ii) obtaining Co-pol and X-pol signal strengths of the one or more target signals received by the first and second beams in step (i); iii) obtaining the Co-pol to X-pol ratio of each of the one or more target signals; iv) normalizing the generated map; v) normalizing the Co-pol to X-pol ratios of the one or more target signals; and vi) for each target signal: finding area(s), within the normalized generated map, which substantially match the normalized Co-pol to X-pol ratio of the target signal; and identifying said area(s) of the normalized generated map as potential direction(s) of arrival of the target signal.

The method may further comprise, vii) adjusting a configuration of the first and/or second beam; and viii) repeating steps (i) through (vii) until the direction of arrival of each of the one or more target signals is obtained.

The step of adjusting the configuration of the first and/or second beam may comprise fixing a direction of the first beam and rotating a direction of the second beam in different azimuth and elevation angles.

The step of adjusting the configuration of the first and/or second beam may further comprise rotating a direction of the first beam with different step angles to point at different directions and rotating a direction of the second beam in different azimuth and elevation angles.

The step of adjusting the configuration of the first and/or second beam may be based on the identified potential direction(s) of arrival of the one or more target signals.

The method may further comprise a step of generating the reference map representing a ratio of a Co-pol pattern produced by the first beam pointing at a boresight direction to a X-pol pattern produced by the second beam pointing at a horizontal direction perpendicular to the boresight direction, wherein the step of normalizing the generated map may further comprise subtracting the generated map from the reference map.

The method may further comprise a step of obtaining reference Co-pol to X-pol ratios of each of the target signals produced by the first beam pointing at a boresight direction to a X-pol pattern produced by the second beam pointing at a horizontal direction perpendicular to the boresight direction, wherein the step of normalizing the Co-pol to X-pol ratios of the one or more target signals may further comprise subtracting the generated ratios from the reference ratios.

The method may further comprise performing calibration of the antenna array to accurately control the Co-pol and X-pol patterns created by the first and second beam configurations.

The method may further comprise setting a threshold level such that only signals having a Co-pol signal strength that are above the threshold level are detected as target signals.

The first beam may be a right-handed circular polarization (RHCP) beam and the second beam may be a left-handed circular polarization (LHCP) beam; or the first beam may be a LHCP beam and the second beam may be a RHCP beam.

The antenna array may comprise a plurality of antenna elements, each antenna element comprising a first feeding port and a second feeding port; wherein the method may further comprise exciting the plurality of antenna elements via the first feeding ports to generate the first beam and exciting the plurality of antenna elements via the second feeding ports to generate the second beam.

The plurality of antenna elements may be collectively arranged in a square or rectangular lattice configuration having a first direction and a second direction, wherein the second direction is substantially perpendicular to the first direction, and wherein any two immediately adjacent antenna elements positioned along the first direction and any two immediately adjacent antenna elements positioned along the second direction are separated by a distance of 0.5 λ, where λ represents free space wavelength at an operating frequency.

The first and second feeding ports of each antenna element may be orthogonally orientated with respect to each other.

The first beam and the second beam generated by the antenna array may be independently controllable.

The first beam and second beam may be configured to further provide nulling capabilities at a specific direction of arrival.

An area, within the normalized generated map, may be considered to substantially match the normalized Co-pol to X-pol ratio for the one or more target signals, if they are within 3 dB of each other.

The method may further comprise accounting for magnitude fluctuations of the target signals when switching between various configurations.

In accordance with a second aspect of the present disclosure, there is provided a system for detecting a direction of arrival of one or more target signals, the system comprising, an antenna array configured to form a first and a second beam in various configurations; and a processor module coupled to the antenna array and configured to: i) generate a map representing a ratio of a co-polarization (Co-pol) pattern received by the first beam to a cross-polarization (X-pol) pattern received by the second beam; ii) obtain Co-pol and X-pol signal strengths of the one or more target signals received by the first and second beams in (i); iii) obtain the Co-pol to X-pol ratio of each of the one or more target signals; iv) normalize the generated map; v) normalize the Co-pol to X-pol ratios of the one or more target signals; and vi) for each target signal: find area(s), within the normalized generated map, which substantially match the normalized Co-pol to X-pol ratio of the target signal; and identify said area(s) of the normalized generated map as potential direction(s) of arrival of the target signal.

The antenna array may comprise a plurality of antenna elements, each antenna element comprising a first feeding port and a second feeding port; wherein the plurality of antenna elements are configured to be excited via the first feeding ports to generate the first beam and configured to be excited via the second feeding ports to generate the second beam.

In accordance with a third aspect of the present disclosure, there is provided a computer readable storage medium having stored thereon instructions for instructing a processing unit of an antenna array configured to form a first and a second beam in various configurations to execute a method of detecting a direction of arrival of one or more target signals using the antenna array, the method comprising, i) generating a map representing a ratio of a co-polarization (Co-pol) pattern received by the first beam to a cross-polarization (X-pol) pattern received by the second beam; ii) obtaining Co-pol and X-pol signal strengths of the one or more target signals received by the first and second beams in step (i); iii) obtaining the Co-pol to X-pol ratio of each of the one or more target signals; iv) normalizing the generated map; v) normalizing the Co-pol to X-pol ratios of the one or more target signals; vi) for each target signal: finding area(s), within the normalized generated map, which substantially match the normalized Co-pol to X-pol ratio of the target signal; and identifying said area(s) of the normalized generated map as potential direction(s) of arrival of the target signal.

### BRIEF DESCRIPTION OF THE DRAWINGS

Exemplary embodiments of the invention will be better understood and readily apparent to one of ordinary skill in the art from the following written description, by way of example only, and in conjunction with the drawings, in which:

FIG. 1 is a schematic flowchart for illustrating a method of detecting a direction of arrival of one or more target signals using an antenna array configured to form a first and a second beam in various configurations in an example embodiment.

FIG. 2 is a schematic diagram of a system, e.g., localization system for detecting a direction of arrival of one or more target signals in an example embodiment.

FIG. 3 is a schematic diagram of an antenna array in an example embodiment.

FIG. 4A is a first plot of a manipulated radiation pattern from a CP port of the antenna array of FIG. 3 in an example embodiment.

FIG. 4B is a second plot of a manipulated radiation pattern from the CP port in the example embodiment.

FIG. 5A is a polarization diagram in a GNSS spoofing signal detection application in an example embodiment.

FIG. 5B is a Range-Doppler Map of a FMCW radar showing a walking person detected on the map in an example embodiment.

FIG. 6 is a schematic flowchart for illustrating a method of detecting a direction of arrival of one or more target signals using an antenna array configured to form a first beam (e.g., RHCP beam) and a second beam (e.g., LHCP beam) in various configurations in another example embodiment.

FIG. 7A is a schematic diagram of an antenna array in an example embodiment.

FIG. 7B are plots of radiation patterns produced by the antenna array in the example embodiment.

FIG. 8A is a plot showing a generated RHCP pattern in an example embodiment.

FIG. 8B is a plot showing a generated LHCP pattern in the example embodiment.

FIG. 8C is a plot showing the ratio Mo when the RHCP beam is pointing to the boresight and LHCP is pointing to [45°, 0°] in the example embodiment.

FIG. 9A is a plot of map |M₁-T_{1,1}| in an example embodiment.

FIG. 9B is a plot of map |M₁-T_{2,1}| in an example embodiment.

FIG. 10A is a plot of map |Mᵢ-T_{1,i}| in an example embodiment.

FIG. 10B is a plot of map |Mᵢ-T_{2,i}| in an example embodiment.

FIG. 10C is a plot of map |Mⱼ-T_{1,j}| in an example embodiment.

FIG. 10D is a plot of map |Mⱼ-T_{2,j}| in an example embodiment.

FIG. 11A is a plot showing Target 1 with an X-pol signal 0-9 dB lower than noise floor in an example embodiment.

FIG. 11B is a plot showing Target 1 with an X-pol signal 0-18 dB lower than noise floor in an example embodiment.

FIG. 11C is a plot showing Target 2 with an X-pol signal 0-7 dB lower than noise floor in an example embodiment.

FIG. 11D is a plot showing Target 2 with an X-pol signal 0-18 dB lower than noise floor in an example embodiment.

FIG. 12A is a plot of a first target detected using a 2×2 array with a conventional AF method in an example embodiment.

FIG. 12B is a plot of a second target detected using the 2×2 array with the conventional AF method in the example embodiment.

FIG. 12C is a plot of the first target detected using a 16×16 array with the conventional AF method in the example embodiment.

FIG. 12D is a plot of the second target detected using the 16×16 array with the conventional AF method in the example embodiment.

FIG. 13 is a schematic drawing of a computer system suitable for implementing an example embodiment.

### DETAILED DESCRIPTION

Example, non-limiting embodiments may provide a system and method of detecting a direction of arrival of one or more target signals using an antenna array. In various embodiments, the signal may be a target signal applicable to radar or related applications where the system transmits signals and subsequently senses for “target” signals reflected from the system-transmitted signal. In other embodiments, the signal may be a “source” signal applicable to GNSS or related applications where the system does not transmit, but only senses for arriving “source” signals.

### Method of Detecting a Direction of Arrival of One or More Target Signals

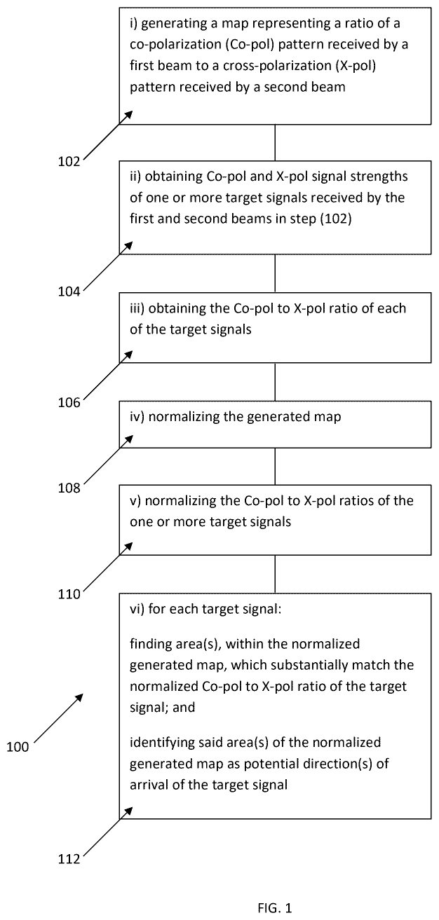

FIG. 1 is a schematic flowchart 100 for illustrating a method of detecting a direction of arrival of one or more target signals using an antenna array configured to form a first and a second beam in various configurations in an example embodiment. The target signal may be a signal reflected or generated by a moving object, e.g., person, vehicle.

At step (102), a map representing a ratio of a co-polarization (Co-pol) pattern received by the first beam to a cross-polarization (X-pol) pattern received by the second beam is generated. The Co-pol and X-pol patterns may be circularly polarized radiation patterns. The first beam may be a right-handed circular polarization (RHCP) beam and the second beam may be a left-handed circular polarization (LHCP) beam. Alternatively, the first beam may be a LHCP beam and the second beam may be a RHCP beam. That is, the first and second beams may have opposite directions of polarization. The first beam and the second beam generated by the antenna array may be independently controllable. The first beam and the second beam may be generated simultaneously or separately depending on the application.

At step (104), Co-pol and X-pol signal strengths of the one or more target signals received by the first and second beams in step (102) are obtained.

At step (106), the Co-pol to X-pol ratio of each of the one or more target signals is obtained.

At step (108), the generated map is normalized. In the example embodiment, the step of normalizing the generated map may comprise subtracting the generated map from a reference map.

At step (110), the Co-pol to X-pol ratios of the one or more target signals are normalized. In the example embodiment, the step of normalizing the Co-pol to X-pol ratios of the one or more target signals may comprise subtracting the generated ratios from reference ratios obtained from the reference map. Accordingly, the method may further comprise a step of obtaining reference Co-pol to X-pol ratios of each of the target signals produced by the first beam pointing at a boresight direction to a X-pol pattern produced by the second beam pointing at a horizontal direction perpendicular to the boresight direction.

At step (112), a search is performed for each target signal to find area(s), within the normalized generated map, which substantially match the normalized Co-pol to X-pol ratio of the target signal; and said area(s) of the normalized generated map is identified as potential direction(s) of arrival of the target signal. In the example embodiment, an area within the normalized generated map may be considered to substantially match the normalized Co-pol to X-pol ratio for the one or more target signals, if they are within 3 dB of each other. Alternatively, the 3 dB threshold can be changed into other values (e.g., 1, 2, 4, 5, 6, 7, 8, 9 or 10 dB etc.) according to different desired tolerance levels of signal fluctuations.

In the example embodiment, the method may further comprise an initialization step prior to generating the map in step 102. For example, the initialization step may comprise performing calibration of the antenna array to accurately control the Co-pol and X-pol patterns created by the first and second beam configurations. The initialization step may further comprise a step of generating the reference map representing a ratio of a Co-pol pattern produced by the first beam pointing at a boresight direction to a X-pol pattern produced by the second beam pointing at a horizontal direction perpendicular to the boresight direction. The initialization step may further comprise a step of setting a threshold level such that only signals having a Co-pol signal strength that are above the threshold level are detected as target signals.

In the example embodiment, the method may further comprise an iteration step after step 112 is completed. For example, the iteration step may comprise adjusting a configuration of the first and/or second beam. The iteration step may further comprise repeating the steps 102 through 112 for each new configuration until the direction of arrival of each of the one or more target signals is obtained. In the example embodiment, adjusting the configuration of the first and/or second beam may comprise fixing a direction of the first beam and rotating a direction of the second beam in different azimuth and elevation angles. In the example embodiment, adjusting the first and/or second beam to a new configuration further comprises rotating a direction of the first beam with different step angles to point at different directions and rotating a direction of the second beam in different azimuth and elevation angles. For example, adjusting the first and/or second beam to a new configuration may comprise rotating the first beam with a step of 90° to point at four different directions (e.g., 0°, 90°, 180°, 270°) and rotating a direction of the second beam in different azimuth and elevation angles. It will be appreciated that the step angle is not limited to 90° and other angles (e.g., 5°, 10°, 15°, 20°, 25°, 30°, 35°, 40°, 45°, 50°, 55°, 60°, 65°, 70°, 75°, 80°, 85° etc.) may be used. In the example embodiment, adjusting the configuration of the first and/or second beam is based on the identified potential direction(s) of arrival of the one or more target signals.

In the example embodiment, the method may further comprise accounting for magnitude fluctuations of the target signals, when switching between various configurations or when adjusting the configurations of the first and/or second beams.

### System for Detecting a Direction of Arrival of One or More Target Signals

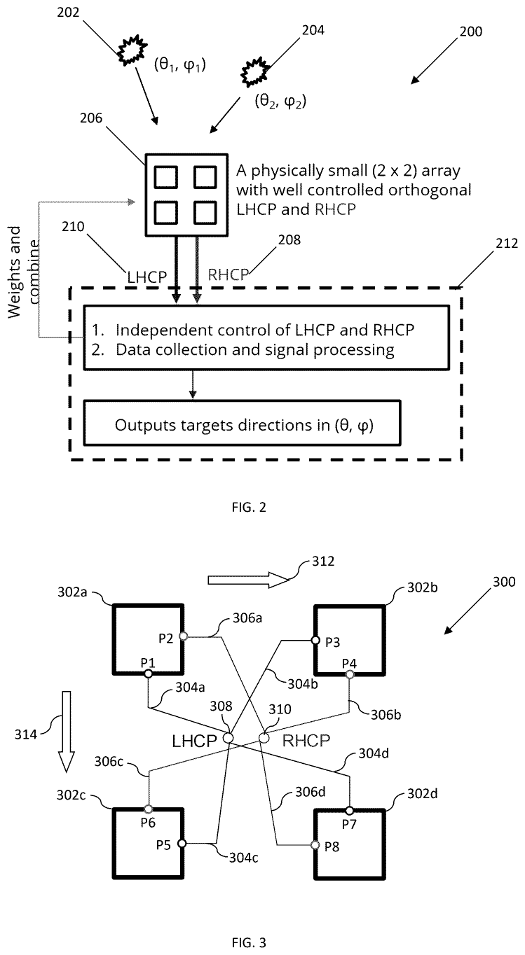

FIG. 2 is a schematic diagram of a system, e.g., localization system (200) for detecting a direction of arrival of one or more target signals (e.g., 202, 204) in an example embodiment.

In the example embodiment, the system (200) comprises an antenna array (206) configured to form a first beam, e.g., RHCP beam (208) and a second beam, e.g., LHCP beam (210) in various configurations. The antenna array (206) may be a physically small (2×2) array capable of generating well controlled orthogonal RHCP beam (208) and LHCP beam (210). The 2×2 antenna array may provide two-dimensional (2D) detection capability.

In the example embodiment, the system (200) further comprises a processor module (212) coupled to the antenna array (206). The processor module (212) is configured to provide excitation signals to the antenna array (206) for generating the RHCP beam (208) and LHCP beam (210). The processor module (212) is further configured to manipulate the excitation signals, e.g., by manipulating the weights of the excitation signals, such that radiation patterns formed by the RHCP beam (208) and LHCP beam (210) can be controlled independently of each other. The processor module (212) is further configured to perform data collection and signal processing. In the example embodiment, the processor module (212) may be capable of storing data that is collected and retrieving data to assist in the signal processing. In some embodiments, the system (200) may further comprise a storage module coupled to the processor module (212), said storage module configured to store data. Examples of data may include accumulated deviations of the Co-pol to X-pol ratios, and potential direction(s) of arrival of the target signal which are kept and used for subsequent computation.

In the example embodiment, the processor module (212) is further configured to: i) generate a map representing a ratio of a co-polarization (Co-pol) pattern received by the first beam to a cross-polarization (X-pol) pattern received by the second beam; ii) obtain Co-pol and X-pol signal strengths of the one or more target signals received by the first and second beams in (i); iii) obtain the Co-pol to X-pol ratio of each of the one or more target signals; iv) normalize the generated map; v) normalize the Co-pol to X-pol ratios of the one or more target signals; and vi) for each target signal: find area(s), within the normalized generated map, which substantially match the normalized Co-pol to X-pol ratio of the target signal; and identify said area(s) of the normalized generated map as potential direction(s) of arrival of the target signal.

Accordingly, in the example embodiment, the processor module (212) is further configured to output the directions of arrival of the one or more target signals (e.g., 202, 204). For example, the directions of arrival may be presented as (θ, φ), where θ represents an angle measured from the Z-axis to the beam and φ represents an angle measured from the X-axis to the projection of the beam in the X-Y plane, wherein the X-Y plane is the plane on which the antenna array receives the target signals.

In the example embodiment, the system (200) comprises both hardware and algorithm working together to provide a high-resolution target localization method using an ultra-small antenna array which seek to achieve comparable or better resolution than antenna arrays known in the art, in two dimensions without increasing the number of elements. The term “ultra small” as used herein broadly refers to an antenna array having no more than 4 antenna elements. In the example embodiment, the inventors used an antenna array with 4 antenna elements to benchmark against antennas known in the art and achieved comparable or better performance. However, it will be appreciated that the antenna array of the system is not limited as such, and may be extended to more than 4 antenna elements.

### Antenna Array

FIG. 3 is a schematic diagram of an antenna array (300) in an example embodiment. The antenna array (300) is substantially similar to the antenna array (206) of FIG. 2. FIG. 3 shows the antenna port configuration of the antenna array (300).

The antenna array (300) comprises a plurality of antenna elements (302a, 302b, 302c, 302d), each antenna element (e.g., 302a) comprising a first feeding port (P1, P3, P5, P7) and a second feeding port (P2, P4, P6, P8). The antenna array (300) further comprises a first feeding network comprising a plurality of first feed lines (304a, 304b, 304c, 304d) communicatively coupling the first feeding port of each of the plurality of antenna elements (302a, 302b, 302c, 302d) to a first source of excitation (308). The antenna array (300) further comprises a second feeding network comprising a plurality of second feed lines (306a, 306b, 306c, 306d) communicatively coupling the second feeding port of each of the plurality of antenna elements (302a, 302b, 302c, 302d) to a second source of excitation (310). The first source of excitation (308) is configured to excite the plurality of antenna elements (302a, 302b, 302c, 302d) via the first feeding network coupled to the respective first feeding ports (P1, P3, P5, P7) to generate a first beam, e.g., a circularly polarized (CP) beam such as a LHCP beam. The second source of excitation (310) is configured to excite the plurality of antenna elements (302a, 302b, 302c, 302d) via the second feeding network coupled to the respective second feeding ports (P2, P4, P6, P8) to generate a second beam, e.g., a CP beam such as a RHCP beam.

In the example embodiment, the plurality of antenna elements (302a, 302b, 302c, 302d) are collectively arranged in a grid or square lattice configuration (i.e., 2×2 formation as shown in FIG. 3) having a first direction (312) and a second direction (314), wherein the second direction (314) is substantially perpendicular to the first direction (312). It will be appreciated that the plurality of antenna elements (302a, 302b, 302c, 302d) may alternatively be collectively arranged in a rectangular lattice configuration. The antenna array (300) comprises a first antenna element (302a), a second antenna element (302b) positioned adjacent to the first antenna element (302a) along the first direction (312), a third antenna element (302c) positioned adjacent to the first antenna element (302a) along the second direction (314), and a fourth antenna element (302d) positioned adjacent to the second antenna element (302b) along the second direction (314). The four antenna elements (302a, 302b, 302c, 302d) are positioned at four corners/vertices of the square lattice configuration. Any two immediately adjacent antenna elements (e.g., between 302a and 302b, between 302c and 302d) positioned along the first direction (312) and any two immediately adjacent antenna elements (e.g., between 302a and 302c, between 302b and 302d) positioned along the second direction (314) may be separated by a distance of 0.5 A, where A represents free space wavelength at an operating frequency. It will be appreciated that the antenna array (300) may be a planar antenna array. In other words, the plurality of antenna elements (302a, 302b, 302c, 302d) are arranged in a 2D manner and are positioned substantially within the same plane.

In the example embodiment, the first and second feeding ports (e.g., P1 and P2) of each antenna element (e.g., 302a) in the antenna array (300) may be orthogonally orientated with respect to each other. That is, the first feeding port (P1) and the second feeding port (P2) of the first antenna element (302a), the first feeding port (P3) and the second feeding port (P4) of the second antenna element (302b), the first feeding port (P5) and the second feeding port (P6) of the third antenna element (302c), and the first feeding port (P7) and the second feeding port (P8) of the fourth antenna element (302d) may be orthogonally orientated with respect to each other.

In the example embodiment, any two antenna elements that are immediately adjacent to each other along the first direction (312) and second direction (314) may be orientated such that one antenna element is rotated at an angle of 90° with respect to the other antenna element to facilitate the connections to the source of excitation. For example, the second antenna element (302b) may be clockwise rotated at an angle of 90° with respect to the first antenna element (302a). The fourth antenna element (302d) may be clockwise rotated at an angle of 90° with respect to the second antenna element (302b). The third element (302c) may be clockwise rotated at an angle of 90° with respect to the fourth antenna element (302d). The first element (302a) may be clockwise rotated at an angle of 90° with respect to the third antenna element (302c).

In the example embodiment, the antenna array (300) is a 2×2 orthogonally polarized linear antennas configured to form controllable LHCP and RHCP patterns, i.e., two orthogonal circularly polarized radiations. The antenna array (300) contains four antenna elements (302a, 302b, 302c, 302d), each of the antenna elements (e.g., 302a) has two orthogonal linear (e.g., Vertical/Horizontal (V/H) or) +/−45° polarization feeding ports with acceptable port isolation (˜−20 dB). During operation, the eight feeding ports (P1-P8) are separated into two groups to form two orthogonal circularly polarized radiation patterns, namely, LHCP and RHCP patterns, from the same aperture. By manipulating the weights of the excitations for the eight ports (P1-P8), the two CP radiation patterns can be controlled.

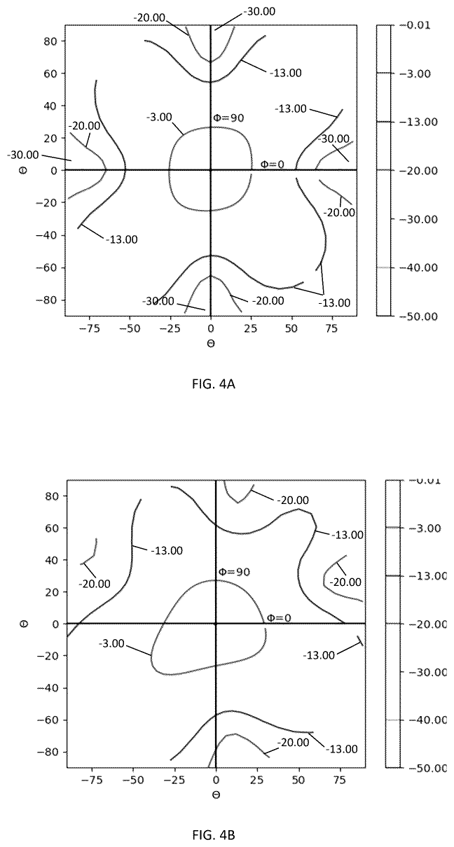

FIG. 4A is a first plot of a manipulated radiation pattern from a CP port of the antenna array (300) of FIG. 3 in an example embodiment. FIG. 4B is a second plot of a manipulated radiation pattern from the CP port in the example embodiment. FIG. 4A and FIG. 4B show two examples of RHCP patterns formed by the antenna array (300), where the nulling areas in the radiation patterns can be changed while the main beam is kept pointing at the boresight. Similar manipulation and results can be expected for LHCP patterns. As shown in FIG. 3, the antenna array (300) has two ports, one for LHCP and the other for RHCP, which combines four linearly polarized ports with a sequentially rotated feeding manner respectively. Each output can have different signals from the same target due to different pattern settings as shown in FIG. 4A and FIG. 4B. The RHCP and LHCP can be obtained by weighting RF channels or using multiple ADC chains to sample the received signals. In embodiments where the weights are in RF domain, then multiple shots are needed to localize one target. In other embodiments where the weights are in digital domain, then only one shot is needed, and the data can be re-used to form different patterns.

### Target Detection

In various embodiments, the method of detecting a direction of arrival of one or more target signals may only process data for detected targets, i.e., for any data that is not detected as targets, the method does not allocate any computing resource. In various embodiments, the detection mechanisms may vary with applications. For example, for GNSS spoofing detection using polarization authentication, suspicious signals are found by the difference between signals obtained by a RHCP port and a LHCP port. For FMCW radar, targets are found in a Range-Doppler Map with Constant False Alarm Rate (CFAR) algorithm. These examples are shown in FIG. 5A and FIG. 5B. FIG. 5A is a polarization diagram in a GNSS spoofing signal detection application in an example embodiment. FIG. 5B is a Range-Doppler Map of a FMCW radar showing a walking person detected on the map in an example embodiment.

Target Direction Finding with CP Matching

In various embodiments, after the target detection, the related data will be selected and further passed to a circular polarization (CP) matching method. In various embodiments, the directions from the targets may be found by comparing the combined signal strength when the signals are weighted differently. Higher accuracy can be achieved when the weighted signals produce larger differences between each other to differentiate the directions in presence of noise. Such differentiation factor is closely related to the array factor.

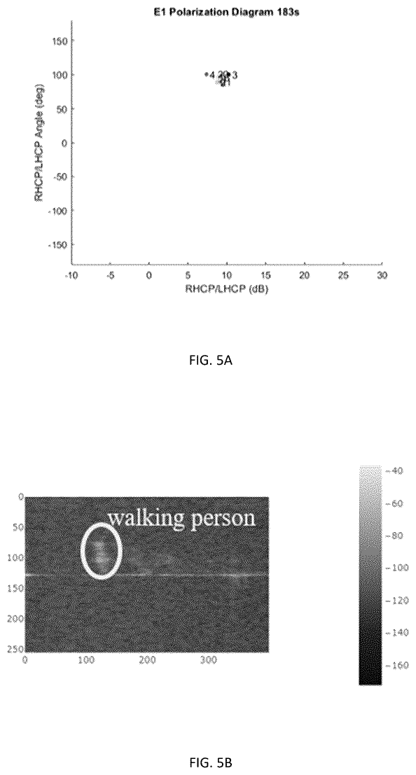

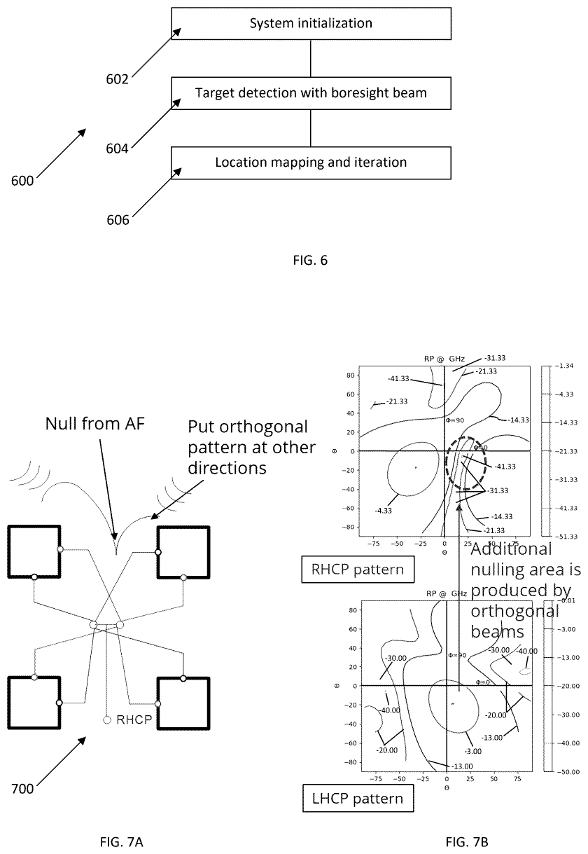

The CP matching method uses the CP manipulation characteristic approach for localization. FIG. 6 is a schematic flowchart (600) for illustrating a method of detecting a direction of arrival of one or more target signals using an antenna array configured to form a first beam (e.g., RHCP beam) and a second beam (e.g., LHCP beam) in various configurations in another example embodiment. The method uses a circular polarization (CP) manipulation characteristic approach for localization of the one or more target signals, with three major steps as outlined under steps (602), (604) and (606).

At step (602), system initialization is performed. System initialization may comprise performing system calibration to provide a foundation to accurately control RHCP and LHCP patterns. System initialization may further comprise generating a reference RHCP/LHCP (Co-pol/X-pol) map (M₀) when the RHCP main beam is looking at boresight and the LHCP beam is pointing at a horizontal direction which is substantially perpendicular to the boresight direction, wherein M₀ represents a matrix of reference Co-pol/X-pol data. It will be appreciated that all maps are based on calibrated element patterns inclusive of the antenna radome. System initialization may further comprise setting a threshold level H (e.g., 3 dB) such that only signals having a Co-pol signal strength that are above the threshold level H are detected as target signals.

At step (604), target detection with boresight beam is performed. Target detection may comprise detecting targets using Co-pol signal. At the detected “locations” from the Co-pol frame (with higher signal to noise ratio (SNR)), e.g., Range-Doppler Map (RDM) for Frequency Modulated Continuous Wave (FMCW) radar or Code/carrier outputs for Global Navigation Satellite System (GNSS), the respective X-pol signal strength is found and the Co-pol/X-pol results (which is a complex number) are recorded:

T₀=[T_{1,0} Co-pol/X-pol, T_{2,0} Co-pol/X-pol, . . . , T_{n,0} Co-pol/X-pol], where

T₀ represents a matrix of the detected target signals at the initial reference scanning round 0

T_{n,0} Co-pol/X-pol represents the Co-pol/X-pol data of a particular target n (e.g., n=1 refers to the 1^{st} target, n=2 refers to the second target and so on) in the reference map (represented by zero).

At step (606), location mapping and iteration is performed. Location mapping and iteration may comprise changing a receiver (Rx) pattern (i.e., adjusting the configuration of the RHCP and/or LHCP), recreating a Co-pol/X-pol map (M′ᵢ) where i represents the iteration of the map created, and normalizing the recreated Co-pol/X-pol map (M′ᵢ) to the reference map M₀, such that the normalized recreated Co-pol/X-pol map Mᵢ is represented by Mᵢ=M′ᵢ-M₀.

Meanwhile, from the same detections, the i^{th} iteration of the detected target signals Tᵢ is obtained from the measured T′ by normalizing it to T₀. i.e., T_{1,i}=T′_{1,i}−T_{1,0}, T_{2,i}=T′_{2,i}−T_{2,0}, . . . , T_{n,i}=T′_{n,i}−T_{n,0}. For each of the targets, the areas within the map Mᵢ, where the variation matches T are found using

|Mᵢ-T_{n, i}|−min(|Mᵢ-T_{n, i}|)<H,

When i increases (the next search), the location mapping will be limited within the areas narrowed in the previous map. In other words, in areas of the map where the variation in the map Mᵢ, matches (or is within a threshold H of) the variation in the target(s) T_{n, i}, the associated directions of these areas are accumulated and kept as potential directions for the next computation. Each round of location mapping narrows down the potential directions within a certain threshold, and after a few rounds of mapping, the direction of the target can be confirmed. Step 606 may be reiterated by fixing RHCP direction and rotating LHCP in different azimuth and elevation angles, then rotating RHCP to four major directions with a step of 90° and rotating LHCP until the potential direction converges to arrive at the direction of arrival (DoA) of the targets. The four major directions refer to φ angles of 0 degree, 90 degree, 180 degree and 270 degree, where φ represents an angle measured from the X-axis to the projection of the beam in the X-Y plane, wherein the X-Y plane is the plane on which the antenna array receives the signals. It will be appreciated that more directional combinations can be used, but the computation time and calculation resource would increase accordingly. For example, the RHCP may be rotated at different step angles (i.e., different φ angles) that are not limited to 90° to point at different directions and the LHCP may be rotated until the potential direction converges to arrive at the direction of arrival (DoA) of the targets.

In the example embodiment, the searching area gets smaller for each round of searching (i.e., the result is accumulated). For example, for the first mapping of Target 1, areas that has a change within the threshold H is kept. In the next mapping, only the kept areas will be mapped so that the searching area gets smaller until the target is found. This process is repeated for the other targets. In the example embodiment, the mapping technique uses CoPol/XPol power ratio rather than big antenna array beam steering.

### Nulling

FIG. 7A is a schematic diagram of an antenna array (700) in an example embodiment. The antenna array (700) is substantially similar to the antenna array (306) of FIG. 3. FIG. 7B are plots of radiation patterns produced by the antenna array (700) in the example embodiment. If necessary (depending on the application), additional nulling capability other than conventional field amplitude superposition (array factor) may be used to remove unwanted interferences in a more flexible way. For example, a first beam and second beam formed by the antenna array (700) may be configured to further provide nulling capabilities at a specific direction of arrival. FIG. 7A and FIG. 7B show that additional nulling capability can be used in interference rejection. For example, in the example embodiment, the first and second beams having opposite circular polarizations can be manipulated/controlled to produce null in particular areas, for one of the circular polarizations. Specifically, as shown in FIG. 7A and FIG. 7B, LHCP signals can still be seen/received (see FIG. 7B), but the RCHP signals cannot be seen/received (see dotted area in FIG. 7A). This nulling method can be used in conjunction with traditional array factor (AF) based nulling techniques, which are independent of beam polarization.

### Simulation for Validating the Method of Detecting a Direction of Arrival of One or More Target Signals Using an Antenna Array

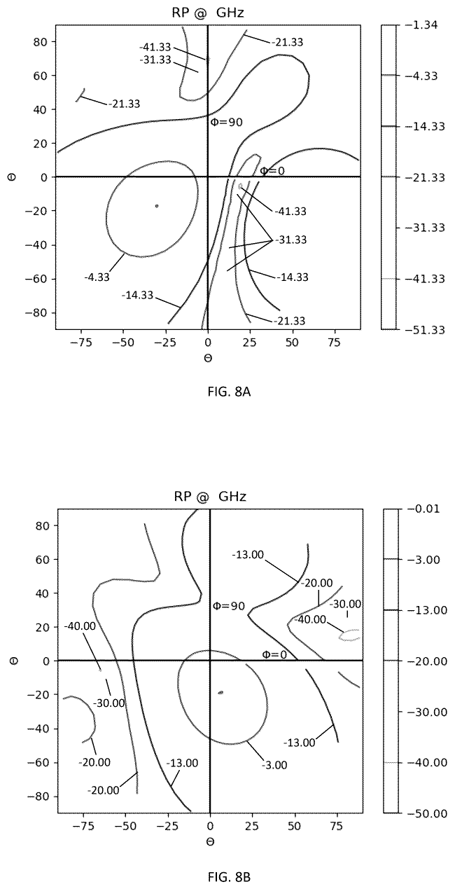

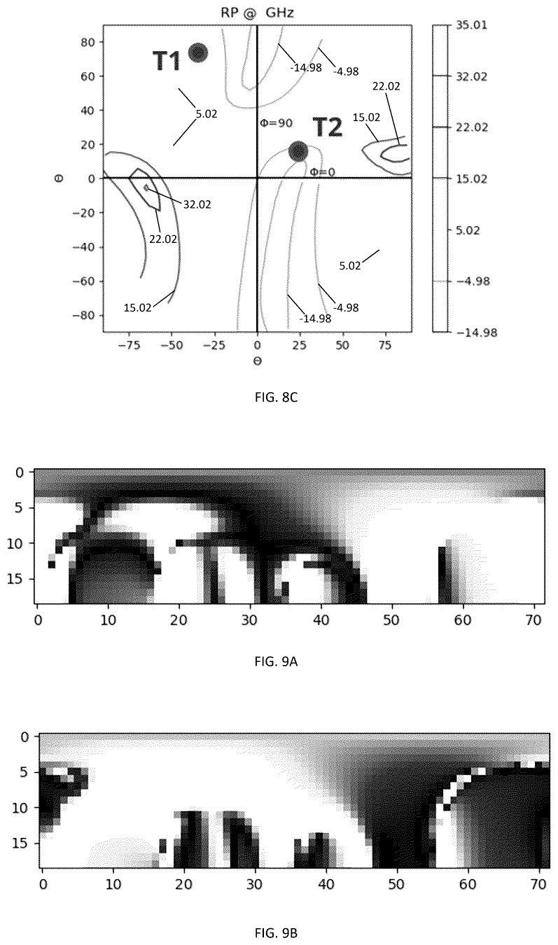

FIG. 8 to FIG. 13 describe a simulation used to validate a method of detecting a direction of arrival (DoA) of one or more target signals using an antenna array in an example embodiment. The antenna array may be a 2×2 orthogonally polarized linear antennas configured to form controllable LHCP and RHCP patterns.

In the simulation, a first target is simulated to be from (θ₁=75°,) (φ₁=120° and a second target is simulated to be from (θ₂=25°,) (φ₂=30°), where θ represents an angle measured from the Z-axis to a vector and φ represents an angle measured from the X-axis to the projection of the vector in the X-Y plane, where the X-Y plane is the receiving plane of the antenna array.

The simulated antenna array detects a first target and a second target with respective Co-Pol/X-Pol ratios of T_{1,0}=12 dB/31° and T_{2,0}=23 dB/125°, in an initial reference map Mo.

The receiver of the antenna array has no actual knowledge of the DoA (Direction of Arrival) of the two targets. During each scan where the CP pattern is manipulated, there may be a fluctuation of signal strength from the same target due to the noise/channel/radar cross-section (RCS) for position change. By setting this random value to be less than X dB (X=3 in the simulation), an allowed fluctuation in signal strength is simulated at the receiver.

A reference map M₀ is obtained by setting RHCP pointing to boresight and LHCP pointing to an arbitrary angle, here a setting of [45°, 0°] is used, and M₀ is known by the system according to measured/simulated antenna pattern. FIG. 8A is a plot showing the generated RHCP pattern in the example embodiment. FIG. 8B is a plot showing the generated LHCP pattern in the example embodiment. FIG. 8C is a plot showing the ratio M₀ when the RHCP beam is pointing to the boresight and LHCP is pointing to [45°, 0°] in the example embodiment. In FIG. 8C, the two targets are also indicated as T1 and T2. It will be appreciated that although the two CP beams are designed to point to the boresight and [45°, 0°], the resulted patterns are deviated as shown in FIG. 8A to FIG. 8C. This is because the two beams are both wide and are interacting with each other within the overlapped region in the space. This has no influence on the accuracy of the method as long as this interaction can be obtained from the simulation or measurement. In the simulation, the antenna array is built by 2×2 elements, each element has two ports to excite horizontal polarization (H-pol) and vertical polarization (V-pol). The port isolation is greater than −19 dB and active element pattern is exported from Computer Simulation Technology (CST) simulation. When proper phase is added, RHCP and LHCP patterns can be produced.

Although the target information is known to the inventors: 12 dB/31°, 23 dB/125°, the antenna receiver in the simulation does not know these target information. Due to different gain for RHCP and LHCP patterns at the two locations, the current measures are T_{1,0}=21.1 dB and T_{2,0}=12.7 dB. It should be noted that these two values are obtained after detection in other matrix like RDM in FMCW radar or tracked channel in GNSS.

Next, the LHCP is adjusted/changed to a configuration (e.g., new steering angle). The same method is repeated to obtain another Co-pol/X-pol map M′₁ which is normalized to the reference map M₀ by computing M₁=M′₁−M₀. Similarly, the receiver gets measured T′_{1,1} and T′_{2,1} and they can be normalized to a reference ratio to obtain T_{1,1} and T_{2,1}. Again the random factor within X dB is added into the result to simulate fluctuations in the received signal strength between configurations. The obtained M₁ is compared with T_{1,1} and T_{2,1}, some region in M₁ will have results within the following range (T_{1,1}−H, T_{1,1}+H), (T_{2,1}−H, T_{2,1}+H) and the result is found in FIG. 9A and FIG. 9B. FIG. 9A is a plot of map |M₁-T_{1,1}| in an example embodiment. FIG. 9B is a plot of map |M₁-T_{2,1}| in an example embodiment. The x-axis represents φ (with a step of 5° and y-axis represents e with a step of 5°. As shown in FIG. 9A and FIG. 9B, the region with large difference (more than H) is in white color. The darker regions mean smaller deviations from T_{1,1} and T_{2,1} are found in M₁.

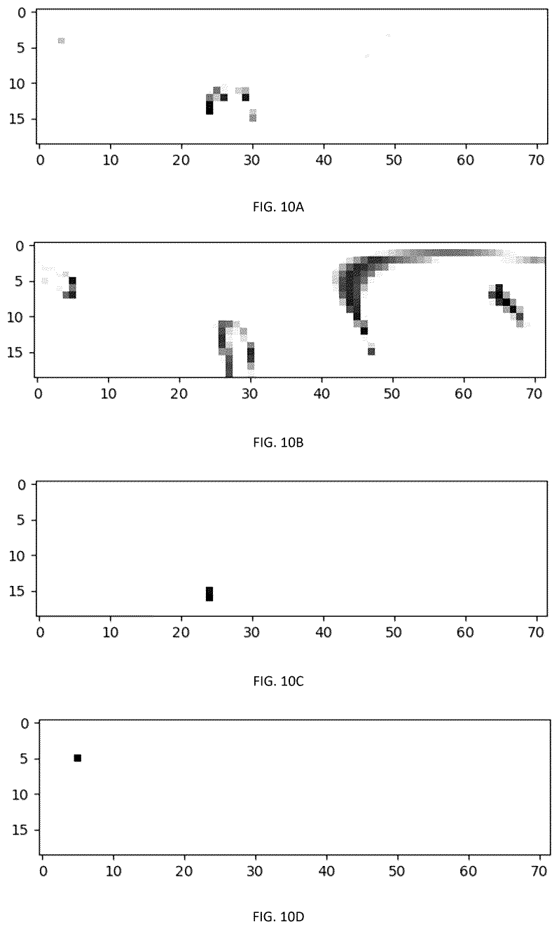

The procedure is repeated when the CP patterns are manipulated. Here in the example, RHCP pattern is fixed but the LHCP beam is steered. Every manipulation leads to a comparison of Mᵢ and T_{1,i}/T_{2,1}, and the accumulated deviations are recorded. FIG. 10A to FIG. 10D show the region with small deviation after a few manipulations. FIG. 10A is a plot of map Mᵢ-T_{1,i} in an example embodiment. FIG. 10B is a plot of map Mᵢ-T_{2,i} in an example embodiment. FIG. 10C is a plot of map Mⱼ-T_{1,j} in an example embodiment. FIG. 10D is a plot of map Mⱼ-T_{2,j} in an example embodiment. The x-axis represents φ with a step of 5° and y-axis represents θ with a step of 5°. It is clear that meaningful manipulations filter out the regions with relatively large accumulated deviations and leave only the relatively small deviation directions. Based on the results, the directions of the two targets can be found from the method.

It will be appreciated that a larger noise fluctuation will degrade the localization accuracy. Further, good accuracy can be achieved when the difference between Co-pol and X-pol increases by manipulating the RHCP and LHCP patterns.

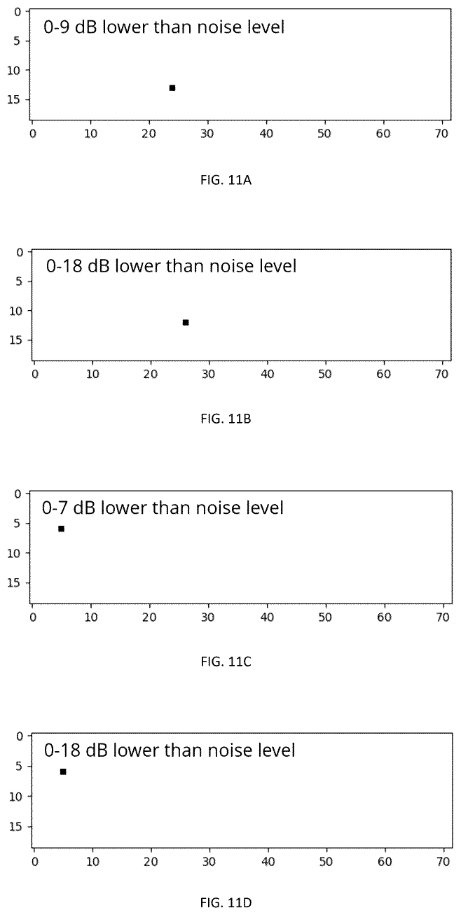

On the other hand, in reality, the X-pol signal may have limited power lower than a noise floor. The RHCP/LHCP ratio may therefore be affected due to the receiver sensitivity. The method in the step (606) may minimize such an effect as shown in FIG. 11A to FIG. 11D. FIG. 11A is a plot showing Target 1 with an X-pol signal 0-9 dB lower than noise floor in an example embodiment. FIG. 11B is a plot showing Target 1 with an X-pol signal 0-18 dB lower than noise floor in an example embodiment. FIG. 11C is a plot showing Target 2 with an X-pol signal 0-7 dB lower than noise floor in an example embodiment. FIG. 11D is a plot showing Target 2 with an X-pol signal 0-18 dB lower than noise floor in an example embodiment. The X-axis represents φ from 0° to 360°, each unit representing 5°, and the Y-axis represents θ from 0° to 90°, each unit representing 5°. It is apparent that the method described herein is capable of accurately detecting direction of arrival of the target signals, when the signal level is 0-18 dB lower than the noise floor. When the signal level is 18 dB lower than the noise floor, the direction-finding algorithm may produce inaccuracies.

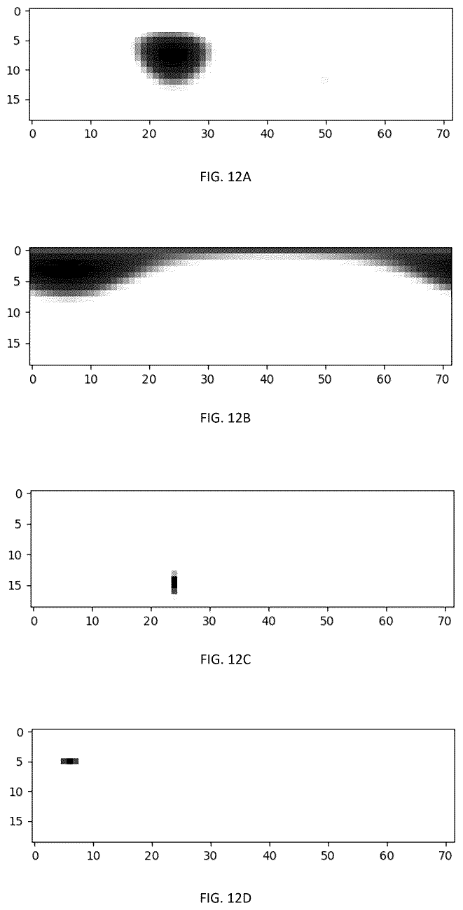

The capabilities of the method as disclosed herein are compared with a conventional array factor (AF) based direction finding method. FIG. 12A is a plot of a first target detected using a 2×2 array with the conventional AF method in an example embodiment. FIG. 12B is a plot of a second target detected using the 2×2 array with the conventional AF method in the example embodiment. FIG. 12C is a plot of a first target detected using a 16×16 array with the conventional AF method in an example embodiment. FIG. 12D is a plot of a second target detected using the 16×16 array with the conventional AF method in the example embodiment. The X-axis represents φ from 0° to 360°, each unit representing 5°, and the Y-axis represents θ from 0° to 90°, each unit representing 5°. For comparison, a 2×2 array and 16×16 array are used to implement the conventional AF based direction finding to locate the same two targets used in the preceding simulation. Comparing FIG. 12C and FIG. 12D with

FIG. 10C and FIG. 10D, it is observed that similar performance is achieved. That is, the plots in FIG. 12C and FIG. 12D which are produced using a conventional AF method implemented on a 16×16 antenna array, is comparable to the plots in FIG. 10C and FIG. 10D which are produced using the method as disclosed herein, implemented on a 2×2 antenna array. FIG. 12A and FIG. 12B show the performance achieved by a 2×2 array and the conventional AF method. Therefore, the results show that a system with a 2×2 antenna array implementing the method as disclosed herein can achieve comparable performance as the conventional systems with 16×16 array, and can outperform the conventional systems with 2×2 array in in terms of direction finding.

It will be appreciated that the antenna array and method as disclosed herein can be extended and applied to a larger array or reduced to a smaller array to two-directional direction finding or one-directional direction finding. With these variations, the locations of the two orthogonal linear polarized antennas or feedings can vary, but the LHCP and RHCP patterns can be formed in the far-field space.

In the described example embodiment, a localization method using an antenna array, e.g., 2×2 antenna array with eight linear excitation ports, is provided to detect a direction of arrival of one or more targets. The eight ports are used to produce two controllable orthogonal circularly polarized patterns, which produces the Co-pol/X-pol (both are CP) ratio of the targets. When the CP patterns are manipulated, the same target shows different Co-pol/X-pol ratio for each manipulation, and this difference is used to find the direction of the target. Because the Co-pol and X-pol can be controlled separately, when the 2×2 array is used, large ratio variation can be obtained to differentiate different angles just like AF of a much larger array (more than 16×16).

In the described example embodiment, a localization method is provided to differentiate two-dimensional (azimuth and elevation) direction of arrival of targets using 2×2antenna array with controlled LHCP/RHCP patterns. The localization method can advantageously achieve the same angle resolution and reduces the number of antennas by at least 98%. The method and system in the described example embodiments may be used in GNSS spoofing detection systems, and may be used in radar and other RF sensing systems. The method and system in the described example embodiment may further provide one more dimension of nulling capability as compared to conventional AF based arrays

The terms “coupled” or “connected” as used in this description are intended to cover both directly connected or connected through one or more intermediate means, unless otherwise stated.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g. medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in Bluetooth technology. The computer program when loaded and executed on a suitable reader effectively results in an apparatus that can implement the steps of the described methods.

The example embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the example embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

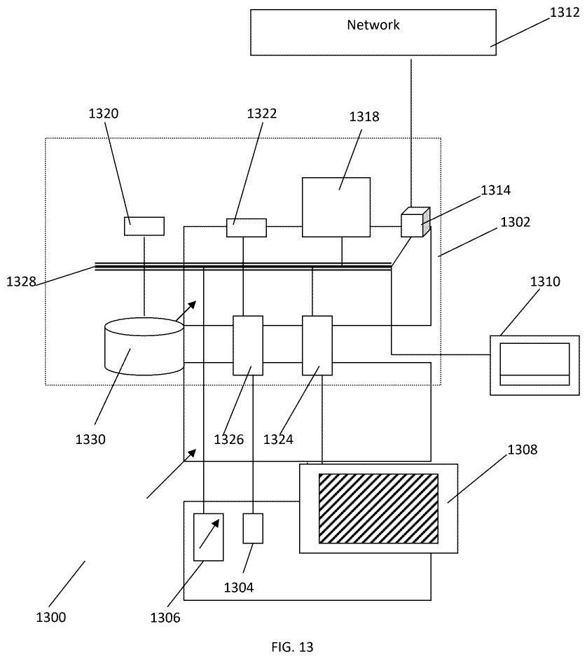

FIG. 13 is a schematic diagram of a computer system 1300 suitable for implementing an example embodiment. Different example embodiments can be implemented in the context of data structure, program modules, program and computer instructions executed in a computer implemented environment. A general purpose computing environment is briefly disclosed herein. One or more example embodiments may be embodied in one or more computer systems, such as is schematically illustrated in FIG. 13.

One or more example embodiments may be implemented as software, such as a computer program being executed within a computer system 1300, and instructing the computer system 1300 to conduct a method of an example embodiment.

The computer system 1300 comprises a computer unit 1302, input modules such as a keyboard 1304 and a pointing device 1306 and a plurality of output devices such as a display 1308, and printer 1310. A user can interact with the computer unit 1302 using the above devices. The pointing device can be implemented with a mouse, track ball, pen device or any similar device. One or more other input devices (not shown) such as a joystick, game pad, satellite dish, scanner, touch sensitive screen or the like can also be connected to the computer unit 1302. The display 1308 may include a cathode ray tube (CRT), liquid crystal display (LCD), field emission display (FED), plasma display or any other device that produces an image that is viewable by the user.

The computer unit 1302 can be connected to a computer network 1312 via a suitable transceiver device 1314, to enable access to e.g. the Internet or other network systems such as Local Area Network (LAN) or Wide Area Network (WAN) or a personal network. The network 1312 can comprise a server, a router, a network personal computer, a peer device or other common network node, a wireless telephone or wireless personal digital assistant. Networking environments may be found in offices, enterprise-wide computer networks and home computer systems etc. The transceiver device 1314 can be a modem/router unit located within or external to the computer unit 1302, and may be any type of modem/router such as a cable modem or a satellite modem.

It will be appreciated that network connections shown are exemplary and other ways of establishing a communications link between computers can be used. The existence of any of various protocols, such as TCP/IP, Frame Relay, Ethernet, FTP, HTTP and the like, is presumed, and the computer unit 1302 can be operated in a client-server configuration to permit a user to retrieve web pages from a web-based server. Furthermore, any of various web browsers can be used to display and manipulate data on web pages.

The computer unit 1302 in the example comprises a processor 1318, a Random Access Memory (RAM) 1320 and a Read Only Memory (ROM) 1322. The ROM 1322 can be a system memory storing basic input/output system (BIOS) information. The RAM 1320 can store one or more program modules such as operating systems, application programs and program data.

The computer unit 1302 further comprises a number of Input/Output (I/O) interface units, for example I/O interface unit 1324 to the display 1308, and I/O interface unit 1326 to the keyboard 1304. The components of the computer unit 1302 typically communicate and interface/couple connectedly via an interconnected system bus 1328 and in a manner known to the person skilled in the relevant art. The bus 1328 can be any of several types of bus structures including a memory bus or memory controller, a peripheral bus, and a local bus using any of a variety of bus architectures.

It will be appreciated that other devices can also be connected to the system bus 1328. For example, a universal serial bus (USB) interface can be used for coupling a video or digital camera to the system bus 1328. An IEEE 1394 interface may be used to couple additional devices to the computer unit 1302. Other manufacturer interfaces are also possible such as FireWire developed by Apple Computer and i.Link developed by Sony. Coupling of devices to the system bus 1328 can also be via a parallel port, a game port, a PCI board or any other interface used to couple an input device to a computer. It will also be appreciated that, while the components are not shown in the figure, sound/audio can be recorded and reproduced with a microphone and a speaker. A sound card may be used to couple a microphone and a speaker to the system bus 1328. It will be appreciated that several peripheral devices can be coupled to the system bus 1328 via alternative interfaces simultaneously.

An application program can be supplied to the user of the computer system 1300 being encoded/stored on a data storage medium such as a CD-ROM or flash memory carrier. The application program can be read using a corresponding data storage medium drive of a data storage device 1330. The data storage medium is not limited to being portable and can include instances of being embedded in the computer unit 1302. The data storage device 1330 can comprise a hard disk interface unit and/or a removable memory interface unit (both not shown in detail) respectively coupling a hard disk drive and/or a removable memory drive to the system bus 1328. This can enable reading/writing of data. Examples of removable memory drives include magnetic disk drives and optical disk drives. The drives and their associated computer-readable media, such as a floppy disk provide nonvolatile storage of computer readable instructions, data structures, program modules and other data for the computer unit 1302. It will be appreciated that the computer unit 1302 may include several of such drives. Furthermore, the computer unit 1302 may include drives for interfacing with other types of computer readable media.

The application program is read and controlled in its execution by the processor 1318. Intermediate storage of program data may be accomplished using RAM 1320. The method(s) of the example embodiments can be implemented as computer readable instructions, computer executable components, or software modules. One or more software modules may alternatively be used. These can include an executable program, a data link library, a configuration file, a database, a graphical image, a binary data file, a text data file, an object file, a source code file, or the like. When one or more computer processors execute one or more of the software modules, the software modules interact to cause one or more computer systems to perform according to the teachings herein.

The operation of the computer unit 1302 can be controlled by a variety of different program modules. Examples of program modules are routines, programs, objects, components, data structures, libraries, etc. that perform particular tasks or implement particular abstract data types. The example embodiments may also be practiced with other computer system configurations, including handheld devices, multiprocessor systems, microprocessor-based or programmable consumer electronics, network PCs, minicomputers, mainframe computers, personal digital assistants, mobile telephones and the like. Furthermore, the example embodiments may also be practiced in distributed computing environments where tasks are performed by remote processing devices that are linked through a wireless or wired communications network. In a distributed computing environment, program modules may be located in both local and remote memory storage devices.

The example embodiments may also be practiced with other computer system configurations, including handheld devices, multiprocessor systems/servers, microprocessor-based or programmable consumer electronics, network PCs, minicomputers, mainframe computers, personal digital assistants, mobile telephones and the like. Furthermore, the example embodiments may also be practiced in distributed computing environments where tasks are performed by remote processing devices that are linked through a wireless or wired communications network. In a distributed computing environment, program modules may be located in both local and remote memory storage devices.

In example embodiments, the antenna array is described as a 2×2 or 16×16 array of antenna elements. However, it will be appreciated that the antenna array is not limited as such and may be configured to comprise other numbers of antenna elements.

It will be appreciated by a person skilled in the art that other variations and/or modifications may be made to the specific embodiments without departing from the scope of the invention as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A method of detecting a direction of arrival of one or more target signals using an antenna array configured to form a first and a second beam in various configurations, the method comprising,
i) generating a map representing a ratio of a co-polarization (Co-pol) pattern received by the first beam to a cross-polarization (X-pol) pattern received by the second beam;
ii) obtaining Co-pol and X-pol signal strengths of the one or more target signals received by the first and second beams in step (i);
iii) obtaining the Co-pol to X-pol ratio of each of the one or more target signals;
iv) normalizing the generated map;
v) normalizing the Co-pol to X-pol ratios of the one or more target signals; and
vi) for each target signal:
finding area(s), within the normalized generated map, which substantially match the normalized Co-pol to X-pol ratio of the target signal; and
identifying said area(s) of the normalized generated map as potential direction(s) of arrival of the target signal.

2. The method of claim 1, further comprising,
vii) adjusting a configuration of the first and/or second beam; and
viii) repeating steps (i) through (vii) until the direction of arrival of each of the one or more target signals is obtained.

3. The method according to claim 2, wherein adjusting the configuration of the first and/or second beam comprises fixing a direction of the first beam and rotating a direction of the second beam in different azimuth and elevation angles.

4. The method according to claim 3, wherein adjusting the configuration of the first and/or second beam further comprises rotating a direction of the first beam with different step angles to point at different directions and rotating a direction of the second beam in different azimuth and elevation angles.

5. The method of claim 2, wherein adjusting the configuration of the first and/or second beam is based on the identified potential direction(s) of arrival of the one or more target signals.

6. The method according to claim 1, further comprising a step of generating the reference map representing a ratio of a Co-pol pattern produced by the first beam pointing at a boresight direction to a X-pol pattern produced by the second beam pointing at a horizontal direction perpendicular to the boresight direction, wherein the step of normalizing the generated map further comprises subtracting the generated map from the reference map.

7. The method according to claim 1, further comprising a step of obtaining reference Co-pol to X-pol ratios of each of the target signals produced by the first beam pointing at a boresight direction to a X-pol pattern produced by the second beam pointing at a horizontal direction perpendicular to the boresight direction, wherein the step of normalizing the Co-pol to X-pol ratios of the one or more target signals further comprises subtracting the generated ratios from the reference ratios.

8. The method according to claim 1, further comprising performing calibration of the antenna array to accurately control the Co-pol and X-pol patterns created by the first and second beam configurations.

9. The method according to claim 1, further comprising setting a threshold level such that only signals having a Co-pol signal strength that are above the threshold level are detected as target signals.

10. The method according to claim 1,
wherein the first beam is a right-handed circular polarization (RHCP) beam and the second beam is a left-handed circular polarization (LHCP) beam; or
wherein the first beam is a LHCP beam and the second beam is a RHCP beam.

11. The method according to claim 1,
wherein the antenna array comprises a plurality of antenna elements, each antenna element comprising a first feeding port and a second feeding port;
wherein the method further comprises exciting the plurality of antenna elements via the first feeding ports to generate the first beam and exciting the plurality of antenna elements via the second feeding ports to generate the second beam.

12. The method according to claim 11,
wherein the plurality of antenna elements are collectively arranged in a square or rectangular lattice configuration having a first direction and a second direction, wherein the second direction is substantially perpendicular to the first direction, and
wherein any two immediately adjacent antenna elements positioned along the first direction and any two immediately adjacent antenna elements positioned along the second direction are separated by a distance of 0.5 λ, where λ represents free space wavelength at an operating frequency of the antenna array.

13. The method according to claim 11, wherein the first and second feeding ports of each antenna element are orthogonally orientated with respect to each other.

14. The method according to claim 1, wherein the first beam and the second beam generated by the antenna array are independently controllable.

15. The method according to claim 1, wherein the first beam and second beam are configured to further provide nulling capabilities at a specific direction of arrival.

16. The method according to claim 1, wherein an area, within the normalized generated map, is considered to substantially match the normalized Co-pol to X-pol ratio for the one or more target signals, if they are within 3 dB of each other.

17. The method according to claim 1, further comprising accounting for magnitude fluctuations of the target signals when switching between various configurations.

18. A system for detecting a direction of arrival of one or more target signals, the system comprising,
an antenna array configured to form a first and a second beam in various configurations; and
a processor module coupled to the antenna array and configured to:
i) generate a map representing a ratio of a co-polarization (Co-pol) pattern received by the first beam to a cross-polarization (X-pol) pattern received by the second beam;
ii) obtain Co-pol and X-pol signal strengths of the one or more target signals received by the first and second beams in (i);
iii) obtain the Co-pol to X-pol ratio of each of the one or more target signals;
iv) normalize the generated map;
v) normalize the Co-pol to X-pol ratios of the one or more target signals; and
vi) for each target signal:
find area(s), within the normalized generated map, which substantially match the normalized Co-pol to X-pol ratio of the target signal; and
identify said area(s) of the normalized generated map as potential direction(s) of arrival of the target signal.

19. The system according to claim 18,
wherein the antenna array comprises a plurality of antenna elements, each antenna element comprising a first feeding port and a second feeding port;
wherein the plurality of antenna elements are configured to be excited via the first feeding ports to generate the first beam and configured to be excited via the second feeding ports to generate the second beam.

20. A computer readable storage medium having stored thereon instructions for instructing a processing unit of an antenna array configured to form a first and a second beam in various configurations to execute a method of detecting a direction of arrival of one or more target signals using the antenna array, the method comprising,
i) generating a map representing a ratio of a co-polarization (Co-pol) pattern received by the first beam to a cross-polarization (X-pol) pattern received by the second beam;
ii) obtaining Co-pol and X-pol signal strengths of the one or more target signals received by the first and second beams in step (i);
iii) obtaining the Co-pol to X-pol ratio of each of the one or more target signals;
iv) normalizing the generated map;
v) normalizing the Co-pol to X-pol ratios of the one or more target signals;
vi) for each target signal:
finding area(s), within the normalized generated map, which substantially match the normalized Co-pol to X-pol ratio of the target signal; and
identifying said area(s) of the normalized generated map as potential direction(s) of arrival of the target signal.
